(19) United States
(12) Patent Application Publication
(10) Pub. No.: US 2024/0132643 A1
(43) Pub. Date: Apr. 25, 2024

(54) Process for Making a Fluoropolymer and Fluoropolymer Made Therefrom

(71) Applicant: 3M INNOVATIVE PROPERTIES COMPANY, St. Paul, MN (US)

(72) Inventors: Tatsuo Fukushi, Woodbury, MN (US); Miguel A. Guerra, Woodbury, MN (US); Klaus Hintzer, Kastl (DE); Joshua E. Malinsky, Stillwater, MN (US); Michael H. Mitchell, Edina, MN (US); Justin T. Roop, Madison, AL (US); Steffen Vowinkel, Mühldorf am Inn (DE)

(21) Appl. No.: 18/546,103

(22) PCT Filed: Feb. 23, 2022
(86) PCT No.: PCT/IB2022/051601

§ 371 Date: Aug. 11, 2023

Related U.S. Application Data
(60) Provisional application No. 63/154,355, filed on Feb. 26, 2021.

(51) Int. Cl. C08F 214/26; C08L 27/18

(52) U.S. Cl. CPC C08F 214/262; C08L 27/18

(57) ABSTRACT

The process includes providing an aqueous mixture including perfluorinated monomers, a fluoroalkyl sulfinic acid or salt thereof, and an oxidizing agent capable of oxidizing the fluoroalkyl sulfinic acid or salt thereof and polymerizing the perfluorinated Nmonomers under free radical conditions to provide an aqueous dispersion of the fluoropolymer. The fluoroalkyl group has from one to three carbon atoms. The amount of perfluorooctanoic acid or salt thereof in the aqueous dispersion of the fluoropolymer as polymerized is not more than 25 nanograms per gram of the fluoropolymer. A fluoropolymer made by the process is also described.

### Background

Fluoropolymers, in particular fluoropolymers with a high content of tetrafluoroethene (TFE, or also referred to as “tetrafluoroethylene”), have achieved outstanding commercial success due in part to their chemical and thermal inertness. Some end-use applications of the polymers include seals for engines, seals in oil-well drilling devices, and sealing elements for industrial equipment that operates at high temperatures or in a chemically aggressive environment. The outstanding properties of fluoropolymers are largely attributable to the stability and inertness of the copolymerized perfluorinated monomer units that make up the major or entire portion of the polymer backbones in these compositions. Such monomers typically include tetrafluoroethene and at least one other perfluorinated monomer.

Fluoropolymers are typically prepared by aqueous emulsion polymerization using fluorinated acid emulsifiers. Perfluorinated alkanoic acids have been used in the past, but they are poorly biodegradable. Therefore, their use is desirably avoided or reduced, or expensive purification methods are used to contain or recycle these emulsifiers. For example, methods have been developed to remove such emulsifiers from aqueous fluoropolymer dispersions, for example by anion exchange as described in U.S. Pat. No. 7,358,296 (Blädel et al.). However, this method requires non-ionic emulsifiers as stabilizers, which may also have to be removed from the isolated polymers for some applications.

Methods have been developed to prepare fluoropolymers without using perfluorinated alkanoic acid emulsifiers, for example, by using alternative fluorinated emulsifiers such as those described, for example, in U.S. Pat. No. 7,671,112 (Hintzer et al.) or non-fluorinated emulsifiers such as those described in U.S. Pat. No. 7,728,087 (Hintzer et al.). However, it has been found that despite avoiding perfluorinated alkanoic acid emulsifiers, such acids may still be generated as side products in the course of aqueous radical polymerizations and found as extractables in the resulting coagulated fluoropolymer reaction products. Int. Appl. Pub. No. W02019/215636 (Hintzer et al.) reports that fluoropolymers with very low amounts of fluorinated alkanoic acid or its salts can be made from a method that includes treating fluoropolymer particles with an organic liquid.

Logothetis, Progress in Polymer Science, Vol. 14, 251-296 (1989) reports that in thermal initiation using a persulfate initiator, the sulfate radical anion acts as the initiator in the presence of fluorinated monomers, and the resulting polymer end groups are carboxylic acid groups resulting from the hydrolysis of the sulfate groups. Ionic and polar end groups are reported to have detrimental effects on rheology (see, e.g., U.S. Pat. No. 4,524,197 (Khan)) and thermal stability (see, e.g., U.S. Pat. No. 4,743,658 (Imbalzano et al.)). Various methods have been reported to reduce ionic and polar end groups in certain fluoropolymers, for example, post-fluorination, heat treatment (see, e.g., U.S. Pat. No. 35 6,211,319 (Schmiegel), and use of fluoroalkyl sulfinic acid or sulfinates and an oxidizing agent to initiate polymerization; (see, e.g., U.S. Pat. Nos. 5,285,002 (Grootaert), 8,604,137 (Grootaert et al.); and 5,639,837 (Farnham et al.).

### Summary

The present disclosure describes the use of a fluoroalkyl sulfinic acid or a salt thereof for fluoropolymer polymerization, in which a fluoroalkyl sulfinic acid or a salt thereof having up to three carbon atoms is selected. Unexpectedly, such fluoroalkyl sulfinic acids or salts provided a level of perfluorooctanoic acid in a fluoropolymer as polymerized that was less than 25 parts per billion while the use of perfluorobutane sulfinic acid (C₄F₉SO₂H) provided a fluoropolymer having 128 parts per billion perfluorooctanoic acid. The ionic end groups in the fluoropolymer were found to be as low regardless of the number of carbon atoms in the fluoroalkyl group. Thus, selection of a fluoroalkyl sulfinic acid or a salt thereof having up to three carbon atoms unexpectedly provides low levels of ionic end groups and perfluorooctanoic acid.

In one aspect, the present disclosure provides a process for making a fluoropolymer. The process includes providing an aqueous mixture including perfluorinated monomers, a fluoroalkyl sulfinic acid or salt thereof, and an oxidizing agent capable of oxidizing the fluoroalkyl sulfinic acid or salt thereof and polymerizing the perfluorinated monomers under free radical conditions to provide an aqueous dispersion of the fluoropolymer. The fluoroalkyl group has from one to three carbon atoms. The amount of perfluorooctanoic acid or salt thereof in the aqueous dispersion of the fluoropolymer as polymerized is not more than 25 nanograms per gram of the fluoropolymer.

In another aspect, the present disclosure provides a fluoropolymer made by the process.

In this application:

Terms such as “a”, “an” and “the” are not intended to refer to only a singular entity but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list or any combination of two or more items in the list.

“Alkyl group” and the prefix “alk-” are inclusive of both straight chain and branched chain groups and of cyclic groups having up to 30 carbons (in some embodiments, up to 20, 15, 12, 10, 8, 7, 6, or 5 carbons) unless otherwise specified. Cyclic groups can be monocyclic or polycyclic and, in some embodiments, have from 3 to 10 ring carbon atoms.

“Alkylene” is the multivalent (e.g., divalent or trivalent) form of the “alkyl” groups defined above.

“Arylalkylene” refers to an “alkylene” moiety to which an aryl group is attached. “Alkylarylene” refers to an “arylene” moiety to which an alkyl group is attached.

The term “aryl” as used herein includes carbocyclic aromatic rings or ring systems, for example, having 1, 2, or 3 rings and optionally containing at least one heteroatom (e.g., 0, S, or N) in the ring and optionally substituted by up to five substituents including one or more alkyl groups having up to 4 carbon atoms (e.g., methyl or ethyl), alkoxy having up to 4 carbon atoms, halo (i.e., fluoro, chloro, bromo or iodo), hydroxy, or nitro groups. Examples of aryl groups include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl.

“As polymerized” refers to the polymerized product before any work-up or post-processing steps, particularly those known to be useful for removing perfluorinated alkanoic acids, e.g., anion exchange, treatment with organic liquid.

The term “perfluoroalkyl group” includes linear, branched, and/or cyclic alkyl groups in which all C—H bonds are replaced by C—F bonds. Likewise, perfluorinated monomers are those in which all C—H bonds are replaced by C—F bonds.

The terms “cure” and “curable” joining polymer chains together by covalent chemical bonds, usually via crosslinking molecules or groups, to form a network polymer. Therefore, in this disclosure the terms “cured” and “crosslinked” may be used interchangeably. A cured or crosslinked polymer is generally characterized by insolubility but may be swellable in the presence of an appropriate solvent.

All numerical ranges are inclusive of their endpoints and nonintegral values between the endpoints unless otherwise stated.

### DETAILED DESCRIPTION

In the process of the present disclosure an aqueous mixture comprising a perfluorinated monomer is provided. In some embodiments, an aqueous mixture comprising perfluorinated monomers is provided, that is, the aqueous mixture includes more than one perfluorinated monomer. Examples of suitable perfluorinated monomers include perfluoroolefins (e.g., tetrafluoroethylene (TFE) and hexafluoropropylene (HFP), and any perfluoroolefin of the formula CF₂=CF—Rf, where Rf is fluorine or a perfluoroalkyl of 1 to 8, in some embodiments 1 to 3, carbon atoms), perfluorinated vinyl ethers (e.g., perfluoroalkyl vinyl ethers (PAVE), and perfluoroalkoxyalkyl vinyl ethers (PAAVE)), and perfluorinated allyl ethers (e.g., perfluoroalkyl allyl ethers (PAAE), and perfluoroalkoxyalkyl allyl ethers (PAAAE)).

Suitable perfluorinated vinyl ethers include those of the formula CF₂=CF—ORf , wherein Rf is a linear, branched, or cyclic perfluorinated alkyl group optionally containing ether linkages, and CF₂=CF(OCₙF₂ₙ)_{z}ORf, wherein Rf is a perfluorinated (C1-C8) alkyl group optionally containing ether linkages, each n is independently 1 to 6, and z is 0 to 6. In some embodiments, Rf has from 1 to 6 or 1 to 4 carbon atoms, each n is independently from 1 to 4 or 1 to 3, and each z is 0 to 4, 0 to 3, or 0 to 2. When more than one CₙF₂ n group is present, n may be independently selected. However, within a CₙF₂ n group, a person skilled in the art would understand that n is not independently selected. CₙF₂ₙ may be linear or branched. In some embodiments, (OCₙF₂ₙ)z is represented by —O—(CF₂)₁₋₄—[O(CF₂)₁₋₄]₀₋₁. Such perfluorinated ethers are described, for example, in U.S. Pat. Nos. 6,255,536 and 6,294,627 (each to Worm et al.) Examples of suitable PAAVE include CF₂═CFOCF₂OCF_{3,} CF₂═CFOCF₂OCF₂CF₃, CF₂═CFOCF₂CF₂OCF₃, CF₂═CFOCF₂CF₂CF₂OCF₃, CF₂═CFOCF₂CF₂CF₂CF₂OCF₃, CF₂═CFOCF₂CF₂OCF₂CF₃, CF₂═CFOCF₂CF₂CF₂OCF₂CF₃, CF₂═CFOCF₂CF₂CF₂CF₂OCF₂CF₃, CF₂═CFOCF₂CF₂OCF₂OCF₃, CF₂═CFOCF₂CF₂OCF₂CF₂OCF₃, CF₂═CFOCF₂CF₂OCF₂CF₂CF₂OCF₃, CF₂═CFOCF₂CF₂OCF₂CF₂CF₂CF₂OCF₃, CF₂═CFOCF₂CF₂OCF₂CF₂CF₂CF₂CF₂OCF₃, CF₂═CFOCF₂CF₂(₀CF₂)₃₀CF₃, CF₂═CFOCF₂CF₂(₀CF₂)₄₀CF₃, CF₂═CFOCF₂CF₂OCF₂OCF₂OCF₃, CF₂═CFOCF₂CF₂OCF₂CF₂CF₃ CF₂═CFOCF₂CF₂OCF₂CF₂OCF₂CF₂CF₃, CF₂═CFOCF₂CF(CF₃)—O—C₃F₇ (PPVE-₂), CF₂═CF(OCF₂CF(CF₃))₂—O—C₃F₇ (PPVE-3), and CF₂═CF(OCF₂CF(CF₃))₃—O—C₃F₇ (PPVE-₄). Examples of suitable PAVE include perfluoro(methyl vinyl) ether CF₂═CFOCF₃, perfluoro(ethyl vinyl) ether CF₂═CFOCF₂CF₃, and perfluoro(n-propyl vinyl) ether CF₂═CFOCF₂CF₂CF₃. Mixtures of PAVE and PAAVE may also be employed.

Other suitable perfluorinated ether monomers include fluoro (alkene ethers) such as those described in U.S. Pat. Nos. 5,891,965 (Worm et al.) and 6,255,535 (Schulz et al.). Further suitable monomers include perfluorinated allyl ethers represented by formula CF₂═CFCF₂(OC nₙF₂ₙ)_{z}ORf, wherein n, z, and Rf are as defined above in any of their embodiments. Examples of suitable perfluoroalkoxyalkyl allyl ethers include CF₂═CFCF₂OCF₂CF₂OCF₃, CF₂═CFCF₂OCF₂CF₂CF₂OCF₃, CF₂═CFCF₂₀CF₂₀CF₃ CF₂═CFCF₂OCF₂OCF₂CF₃, CF₂═CFCF₂OCF₂CF₂CF₂CF₂OCF₃, CF₂═CFCF₂OCF₂CF₂OCF₂CF₃, CF₂═CFCF₂OCF₂CF₂CF₂OCF₂CF₃, CF₂═CFCF₂OCF₂CF₂CF₂CF₂OCF₂CF₃, CF₂═CFCF₂OCF₂CF₂OCF₂OCF₃, CF₂═CFCF₂OCF₂CF₂OCF₂CF₂OCF₃, CF₂═CFCF₂OCF₂CF₂OCF₂CF₂CF₂OCF₃, CF₂═CFCF₂OCF₂CF₂OCF₂CF₂CF₂CF₂OCF₃, CF₂═CFCF₂OCF₂CF₂OCF₂CF₂CF₂CF₂CF₂OCF₃, CF₂═CFCF₂₀CF₂CF₂(₀CF₂)₃OCF₃, CF₂═CFCF₂₀CF₂CF₂(₀CF₂)₄₀CF₃, CF₂═CFCF₂OCF₂CF₂OCF₂OCF₂OCF₃, CF₂═CFCF₂OCF₂CF₂OCF₂CF₂CF₃, CF₂═CFCF₂OCF₂CF₂OCF₂CF₂OCF₂CF₂CF₃, CF₂═CFCF₂OCF₂CF(CF₃)—O—C₃F₇, and CF₂═CFCF₂(OCF₂CF(CF₃))₂—O—C₃F₇. Many of these perfluoroalkoxyalkyl allyl ethers can be prepared, for example, according to the methods described in U.S. Pat. No. 4,349,650 (Krespan). Further suitable perfluorinated allyl ethers include perfluoromethyl allyl ether and perfluoropropyl allyl ether. Perfluoropropyl allyl ether (CF₂═CF—CF₂—OC₃F₇) and perfluoromethoxy ethyl allyl ether (CF₂═CF—CF₂—OC₂F₄OCF₃) can be prepared according to the methods described in U.S. Pat. No. U.S. Pat. No. 5,891,965 (Worm). Perfluoroalkoxyalkyl allyl ethers can also be prepared by combining first components comprising at least one of CF₂═CF—CF₂—OSO₂Cl or CF₂═CF—CF₂—OSO₂CF₃, a polyfluorinated compound comprising at least one ketone or carboxylic acid halide or combination thereof, and fluoride ion. Polyfluorinated compounds comprising at least one ketone or carboxylic acid halide or combination thereof and fluoride ions can be any of those described, for example, in U.S. Pat. No. 4,349,650 (Krespan).

In some embodiments, the perfluorinated monomers comprise tetrafluoroethylene and at least one of a perfluorinated vinyl ether or a perfluorinated allyl ether, wherein the perfluorinated vinyl ether or the perfluorinated allyl ether is perfluoromethyl vinyl ether, perfluoropropyl vinyl ether, perfluoro-3-methoxy-n-propyl vinyl ether, perfluoro-3-methoxy-n-propyl allyl ether, perfluoromethyl allyl ether, perfluoropropyl allyl ether, or a combination thereof.

In some embodiments, the process of the present disclosure is useful for making a fluoropolymer from an aqueous mixture including a halogenated fluoroolefin (e.g., trifluorochloroethylene (CTFE)) and/or a hydrogen-containing monomer such as olefins (e.g., ethylene, propylene, or another non-fluorinated alpha-olefin such as a C₂ to C₉ alpha olefin) and partially fluorinated olefins (e.g., vinylidene fluoride (VDF), pentafluoropropylene, trifluoroethylene, or an olefin in which less than half or less than one-fourth of the hydrogen atoms are replaced with fluorine). In some embodiments, halogen- or hydrogen-containing olefins useful as monomers in the process include those of the formula CX₂═CX—R, wherein each X is independently hydrogen, fluoro, or chloro and R is hydrogen, fluoro, or a C₁—C₁₂, in some embodiments C₁—C₃, alkyl, with the proviso that not all X and R groups are fluoro groups.

In some embodiments, the aqueous mixture further comprises a cure site monomer having at least one of a bromo-, iodo-, or nitrogen-containing cure site. Examples of cure site monomers having a bromo- or iodo- cure site include those of the formula CX₂═CX(Z), wherein each X is independently H or F, and Z is I, Br, or R_{f}—Z, wherein Z is I or Br and Rf is a perfluorinated or partially perfluorinated alkylene group optionally containing O atoms. In addition, non-fluorinated bromo-or iodo-substituted olefins, e.g., vinyl iodide and allyl iodide, can be used. In some embodiments, the cure site monomer is CH₂═CHI, CF₂═CHI, CF₂═CFI, CH₂═CHCH₂I, CF₂═CFCF₂I, CH₂═CHCF₂CF₂I, CF₂═CFCH₂CH₂I, CF₂═CFCF₂CF₂I, CH₂═CH(CF₂)₆CH₂CH₂I, CF₂═CFOCF₂CF₂I, CF₂═CFOCF₂CF₂CF₂I, CF₂═CFOCF₂CF₂CH₂I, CF₂═CFCF₂OCH₂CH₂I, CF₂═CFO(CF₂)₃₀CF₂CF₂I, CH₂═CHBr, CF₂═CHBr, CF₂═CFBr, CH₂═CHCH₂Br, CF₂═CFCF₂Br, CH₂═CHCF₂CF₂Br, CF₂═CFOCF₂CF₂Br, CF₂═CFCl, CF₂═CFCF₂Cl, or a mixture thereof.

Examples of monomers comprising nitrogen-containing groups useful in preparing fluoropolymers comprising a nitrogen-containing cure sites include free-radically polymerizable nitriles, imidates, amidines, amides, imides, and amine-oxides. Mixtures of any of these nitrogen-containing cure sites may be useful in the process of the present disclosure. Useful nitrogen-containing cure site monomers include nitrile-containing fluorinated olefins and nitrile-containing fluorinated vinyl ethers, for example, CF₂═CFO(CF₂)_{L}CN, CF₂═CFO(CF₂)ᵤOCF(CF₃)CN, CF₂═CFO[CF₂CF(CF₃)O]_{q}(CF₂O)_{y}CF(CF₃)CN, or CF₂═CF[OCF₂CF(CF₃)]ᵣO(CF₂)ₜCN, wherein L is in a range from 2 to 12; u is in a range from 2 to 6; q is in a range from 0 to 4; y is in a range from 0 to 6; r is in a range from 1 to 2; and t is in a range from 1 to 4. Examples of such monomers include CF₂═CFO(CF₂)₃OCF(CF₃)CN, perfluoro(8-cyano-5-methyl-3,6-dioxa-1-octene), and CF₂═CFO(CF₂)₅CN.

In some embodiments, the fluorinated monomer(s) comprise at least 25% by weight or at least 44% by weight of TFE, based on the total weight of monomers in the aqueous mixture.

In some embodiments, the aqueous mixture further comprises a chain transfer agent having at least one of a bromo-, iodo-, or nitrogen-containing cure site. Chain-transfer agents are compounds capable of reacting with the propagating polymer chain and terminating the chain propagation. Examples of chain-transfer agents include those having the formula RIₓ, wherein R is an x-valent fluoroalkyl or fluoroalkylene radical having up to 12 carbon atoms, which, may be interrupted by one or more ether oxygens and may also contain chlorine and/or bromine atoms. R may be Rf and Rf may be an x-valent (per)fluoroalkyl or (per)fluoroalkylene radical that may be interrupted once or more than once by an ether oxygen. Examples include alpha-omega diiodo alkanes, alpha-omega diiodo fluoroalkanes, and alpha-omega diiodoperfluoroalkanes, which may contain one or more catenary ether oxygens. “Alpha-omega” denotes that the iodine atoms are at the terminal positions of the molecules. Such compounds may be represented by the general formula X—R—Y with X and Y being I and R being as described above. Specific examples include di-iodomethane, alpha-omega (or 1,4-) diiodobutane, alpha-omega (or 1,3-) diiodopropane, alpha-omega (or 1,5-) diiodopentane, alpha-omega (or 1,6-) diiodohexane and 1,2-diiodoperfluoroethane. Other examples include fluorinated di-iodo ether compounds of the following formula:

R_{f}—CF(I)—(CX₂)ₙ—(CX₂CXR)ₘ—O—R″f—Oₖ—(CXR′CX₂)ₚ—(CX₂)_{q}—CF(I)—R′_{f}

wherein X is independently selected from F, H, and Cl; R_{f} and R′_{f} are independently selected from F and a monovalent perfluoroalkane having 1-3 carbons; R is F, or a partially fluorinated or perfluorinated alkane comprising 1-3 carbons; R″_{f} is a divalent fluoroalkylene having 1-5 carbons or a divalent fluorinated alkylene ether having 1-8 carbons and at least one ether linkage; k is 0 or 1; and n, m, and p are independently selected from an integer from 0-5, wherein, n plus m at least 1 and p plus q are at least 1.

Nitrogen-containing cure sites can be incorporated into the curable fluoropolymer by employing selected chain transfer agents (e.g., I(CF₂)_{d}CN in which d is 1 to 10 or 1 to 6) or by carrying out the free-radical polymerization in the presence of a perfluorosulfinate such as NC(CF₂)dSO₂G, in which G represents a hydrogen atom or a cation with valence of 1 or 2.

The cure-site monomers and/or chain transfer agents typically make up about _{0.1} to ₅ mole percent (in some embodiments, 0.3 to 2 mole percent) of the polymerization components.

The aqueous mixture including monomers useful in the process of the present disclosure also includes a fluoroalkyl sulfinic acid or a salt thereof and an oxidizing agent capable of oxidizing the sulfinic acid or salt thereof to a sulfonyl radical. There are one, two, or three carbon atoms in the fluoroalkyl group of the sulfinic acid or salt thereof. Examples of oxidizing agents include free radical initiators such as a persulfate (e.g., ammonium persulfate, potassium persulfate, or ammonium persulfate), and a permanganic acid or a salt (e.g., potassium permanganate), a chlorate, bromate, or hypochlorite salt (e.g., having an alkali metal or ammoinium cation), a cerium salt (e.g., Ce(SO₄)₂), and oxygen.

The fluoroalkyl sulfinic acid or salt thereof can be represented by formula: R_{f}SO₂M. wherein R_{f} is perfluoromethyl, perfluoroethyl, or perfluoroproyl, and M represents a hydrogen atom or cation. Examples of cations include ammonium cations and alkali metal cations (e.g., lithium, sodium, or potassium). Cations with a 2+valence (e.g., calcium) may also be useful, and the salt can be written as formula R_{f}SO₂M_{1/2} or (R_{f}SO₂)₂M. Useful fluoroalkyl sulfinic acid or salt thereof include trifluoromethanesulfinic acid, sodium trifluoromethanesulfinate, ammonium trifluoromethanesulfinate, potassium trifluoromethanesulfinate, pentafluoroethanesulfinic acid, sodium pentafluoroethanesulfinate, ammonium pentafluoroethanesulfinate, potassium pentafluoroethanesulfinate, perfluoro-n-propanesulfinic acid, sodium perfluoro-n-propanesulfinate, ammonium perfluoro-n-propanesulfinate, potassium perfluoro-n-propanesulfinate, perfluoro-isopropanesulfinic acid, sodium perfluoro-isopropanesulfinate, ammonium perfluoro-isopropanesulfinate, and potassium perfluoro-isopropanesulfinate. In some embodiments, the fluoroalkyl sulfinic acid or salt thereof is not sodium trifluoromethanesulfinate. When the fluoroalkyl sulfinic acid or salt thereof has three carbon atoms in the fluoroalkyl group (e.g., perfluoro-n-propanesulfinic acid, sodium perfluoro-n-propanesulfinate, ammonium perfluoro-n-propanesulfinate, potassium perfluoro-n-propanesulfinate, perfluoro-isopropanesulfinic acid, sodium perfluoro-isopropanesulfinate, ammonium perfluoro-isopropanesulfinate, and potassium perfluoro-isopropanesulfinate), the aqueous mixture can include any fluorinated monomer described above in or any combination of such fluorinated monomers. Fluoroalkyl sulfinic acid and salt thereof can be prepared, for example, by reduction of perfluoroalkane sulfonyl fluorides. The reducing agent can be, for example, sodium borohydride, lithium aluminum hydride, borane, and sodium sulfite, and the reaction can be carried out using the method described in the Examples, below.

As described in Logothetis, Progress in Polymer Science, Vol. 14, 251-296 (1989), in thermal initiation using a persulfate initiator, the sulfate radical anion acts as the initiator in the presence of fluorinated monomers, and the resulting end groups are carboxylic acid groups resulting from the hydrolysis of the sulfate groups in water. In some redox initiated systems, the initiation can take place with either sulfate or sulfite radicals, resulting in the end groups being predominantly carboxylate and sulfonate.

Although we do not want this disclosure to be bound by any theory, it is believed that once the oxidizing agent oxidizes the fluoroalkyl sulfinic acid or salt thereof in the aqueous dispersion to a sulfonyl radical, R_{f}SO₂·, sulfur dioxide gas is released, and R_{f}· radicals are formed and become the end groups of the fluoropolymer produced. In some embodiments, the fluoropolymer has an end group comprising at least one of —CF₃,—CF₂H, —CFH₂, or —CH₃ (in some embodiments, —CF₃) and generally has a low level of ionic end groups (e.g., carboxylate, sulfonate). In some embodiments, an absorbance ratio determined by calculating the integrated peak intensity within the range of 1840 cm⁻¹-1620 cm⁻¹ to the integrated peak intensity in the range 2740 cm⁻¹- 2220 cm₋₁ in a Fourier-transform infrared spectrum of the fluoropolymer is less than 0.1, 0.09, 0.08, 0.075, 0.07, or 0.06. This absorbance ratio has been used in the art to indicate the level of carboxylic end groups; see, e.g., U.S. Pat. Nos. 6,114,452 (Schmiegel et al.) and 8,604,137 (Grootaert et al.).

A chloride salt such as a chloride salt of a mono- or multi-valent cation may be added to the aqueous dispersion in some embodiments. Suitable cations include organic and inorganic cations, in some embodiments, ammonium. Examples of ammonium chloride salts include tetraalkyl ammonium chlorides such as tetrabutyl ammonium chloride as well as NH₄C₁. The presence of a chloride salt may further reduce the number of ionic end groups. Generally, the amount of chloride salt is selected such that the molar ratio of chloride ions to initiator (e.g. permanganate or persulfate) is between 1:0.1 and 0.1:10, preferably between 1:0.5 and 0.1:5.

U.S. Pat. No. 8,604,137 (Grootaert et al.) discloses reducing carbonyl groups using perfluoroalkane sulfinic acid or perfluoroalkane sulfinate, including ammonium perfluorobutane sulfinate (C₄F₉SO₂NH4). However, we have found that perfluorobutane sulfinic acid or a salt thereof can be converted to perfluorooctanoic acid (PFOA) through a C₄ radical reaction with TFE (CF₂═CF2) during polymerization. As shown in Comparative Example 2 in Table 1, when perfluorobutane sulfinic acid (C₄F₉SO₂H) was used in the polymerization, the level of PFOA was 128 parts per billion (ppb).

Unexpectedly, as shown in Examples 1 and 2 in Table 1, using perfluoromethane sulfinic acid (CF₃SO₂H) or perfluoroethane sulfinic acid (CF₃CF₂SO₂H) instead of perfluorobutane sulfinic acid, the PFOA level was significantly reduced to less than 6 ppb or less than 22 ppb, respectively. Also the ionic end groups in the fluoropolymer made with perfluoromethane sulfinic acid were as low as in the fluoropolymer made with perfluorobutane sulfinic acid. In the process of the present disclosure, the amount of perfluorooctanoic acid or salt thereof in the aqueous dispersion of the fluoropolymer as polymerized is not more than 25 nanograms per gram of the fluoropolymer (i.e., parts per billion (ppb) based on the weight of the fluropolymer). In some embodiments of the process of the present disclosure, the amount of perfluorooctanoic acid or salt thereof in the aqueous dispersion of the fluoropolymer as polymerized is not more than 20 ppb, 15 ppb, or 10 ppb, based on the weight of the fluoropolymer.

The molecular weight of the fluoropolymer of the Examples and Comparative Examples was high as indicated by Mooney viscosity. Lower molecular weight fluoropolymers made with a higher concentration of initiator (e.g., persulfate initiator) would have a higher amount of ionic end groups. In Comparative Example 1, which uses no fluoroalkyl sulfinic acid or salt thereof, the number of ionic end groups of the fluoropolymer is significantly higher than in the Examples as indicated by the absorbance ratio determined by calculating the integrated peak intensity within the range of 1840 cm⁻¹-1620 cm⁻¹ the integrated peak intensity in the range 2740 cm⁻¹-2220 cm⁻¹ in a Fourier-transform infrared spectrum. The difference in the number of ionic end groups would be expected to be even greater for a lower molecular weight fluoropolymer.

In some embodiments of the process of the present disclosure, the amount of perfluoroalkanoic acid or salt thereof or perfluoroalkane sulfonic acid or salt thereof in the aqueous dispersion is also reduced in comparison to when perfluorobutane sulfinic acid is used in the polymerization. The perfluoroalkanoic acid or salt thereof or perfluoroalkane sulfonic acid or salt thereof can be represented by formula

F₃C—(CF₂)ₙ—Z—M

wherein n is an integer from 2 to 17, or from 6 to 12, and wherein Z represents —COO⁻ or —SO₃⁻, and M represents a cation selected from alkali metal cations, ammonium ions, and H⁺. The fluoropolymer provided by the process of the present disclosure can contain an amount of fluorinated acid or its salt of the above formula of less than 2000 ppb, 1000 ppb, less than 150 ppb, or even less than 100 ppb (based on the weight of the fluoropolymer). In some embodiments, the amount of perfluoroalkanoic acids having from 8 to 14 carbon atoms or salts thereof (that is, n=6 to 12 and Z represents a carboxylic acid group in formula F₃C—(CF₂)ₙ—Z—M) or perfluoroalkane sulfonic acids having from 8 to 14 carbon atoms or salts thereof in the aqueous dispersion of the fluoropolymer as polymerized is not more than 300 ppb, 250 ppb, 200 ppb, 150 ppb or 100 ppb, based on the weight of the fluoropolymer.

Fluoropolymers are typically prepared by a sequence of steps, which can include polymerization, coagulation, washing, and drying. In some embodiments of the process of the present disclosure, an aqueous emulsion polymerization can be carried out continuously under steady-state conditions. For example, an aqueous emulsion of monomers (e.g., including any of those described above), water, emulsifiers, buffers and catalysts can be fed continuously to a stirred reactor under optimum pressure and temperature conditions while the resulting dispersion is continuously removed. In some embodiments of the process of the present disclosure, batch or semibatch polymerization is conducted by feeding the aforementioned ingredients into a stirred reactor and allowing them to react at a set temperature for a specified length of time or by charging ingredients into the reactor and feeding the monomers into the reactor to maintain a constant pressure until a desired amount of polymer is formed. After polymerization, unreacted monomers are removed from the reactor effluent latex by vaporization at reduced pressure. The curable fluoropolymer can be recovered from the latex by coagulation.

Initiator systems that may be used to initiate the free radical polymerization include initiator systems that generate free radicals through a redox reaction between the fluoroalkyl sulfinic acid or salt thereof and the oxidizing agents. Suitable oxidizing agents for this purpose include persulfates (e.g., ammonium persulfate, potassium persulfate, and sodium persulfate). Other oxidizing agents may also be present in the aqueous mixture as described above. Other reducing agents may also be present in the aqueous mixture, such as a sulfite (e.g., sodium sulfite, sodium bisulfite); a metabisulfite (e.g., sodium or potassium bisulfite); pyrosulfites; and thiosulfates. Additionally, metal ions such as copper, iron, and silver may be used.

When conducting emulsion polymerization, perfluorinated or partially fluorinated emulsifiers may be useful. Polymer particles produced with a fluorinated emulsifier typically have an average diameter, as determined by dynamic light scattering techniques, in range of about 10 nanometers (nm) to about 300 nm, and in some embodiments in range of about 50 nm to about 200 nm. If desired, the emulsifiers can be removed or recycled from the fluoropolymer latex as described in U.S. Pat. Nos. 5,442,097 (Obermeier et al.), 6,613,941 (Felix et al.), 6,794,550 (Hintzer et al.), 6,706,193 (Burkard et al.) and 7,018,541 (Hintzer et al.). In some embodiments, the polymerization process may be conducted with no emulsifier (e.g., no fluorinated emulsifier). Polymer particles produced without an emulsifier typically have an average diameter, as determined by dynamic light scattering techniques, in a range of about 40 nm to about 500 nm, typically in range of about 10 nm and about 400 nm, in some embodiments, 40 nm to 250 nm, and suspension polymerization will typically produce particles sizes up to several millimeters.

In the process of the present disclosure, it is desireable that no perfluoroalkanoic acid or salt thereof is used so that the amount of perfluorooctanoic acid or salt thereof in the aqueous dispersion of the fluoropolymer as polymerized is not more than 25 nanograms per gram of the fluoropolymer. However, one or more fluorinated emulsifiers other than a perfluorinated alkanoic acid or salt thereof may be used.

Useful fluorinated emulsifiers for the process of the present disclosure include those that correspond to the general formula:

[R_{f}—O—L—COO⁻]ᵢXᵢ⁺
wherein L represents a linear or branched or cyclic partially fluorinated alkylene (alkanediyl) group or an aliphatic hydrocarbon group, Rf represents a linear or branched, partially or fully fluorinated aliphatic group or a linear or branched partially or fully fluorinated group interrupted once or more than once by an ether oxygen atom, Xᵢ⁺ represents a cation having the valence i and i is 1, 2 and 3. In some embodiments, the molecular weight of the fluorinated emulsifier is less than 1,500 grams/mole, 1,000 grams/mole, 500 grams/mole. The fluorinated emulsifier may have from 4 to 19 carbon atoms, in some embodiments, from 5 to 14 or from 6 to 12 carbon atoms. Specific examples are described in, for example, U.S. Pat. Publ. No. 2007/0015937 (Hintzer et al.). Examples of such emulsifiers include: CF₃CF₂CH₂OCF₂CH₂OCF₂COOH and CF₃O(CF₂)₃OCHFCF₂COOH, CHF₂(CF₂)₅COOH. The use of one or more non-fluorinated emulsifiers, or a combination of fluorinated non-fluorinated emulsifiers, is also possible. Examples for polymerizations of fluoropolymers with non-fluorinated emulsifiers are described, for example, in U.S. Pat. No. 7,566,762 (Otsuka et al.).

Many initiators and emulsifiers have an optimum pH-range where they show most efficiency. For this reason, buffers are sometimes useful in the aqueous mixture. Buffers include phosphate, acetate or carbonate buffers or any other acid or base, such as ammoniam hydroxides. The concentration range for the initiators and buffers can vary from 0.01% to 5% by weight based on the aqueous polymerization medium. The amount of fluorinated emulsifier may be between 0.1% by weight and 5% by weight based on the weight of fluoropolymer to be produced, and minimizing the amount of emulsifier is desirable. In some embodiments, the amount of initiator employed in the process of the present disclosure is between 0.01% and 2% by weight or between 0.03% and 1% by weight based on the total weight of the aqueous mixture. The full amount of initiator may be added at the start of the polymerization, or the initiator can be added to the polymerization in a continuous way during the polymerization until a conversion of 70% to 80% is achieved. One can also add part of the initiator at the start and the remainder in one or separate additional portions during the polymerization. The polymerization is generally carried out at a temperature in a range from 10° C. and 100° C., or in a range from 30° C. and 80° C. The polymerization pressure is usually in the range of 0.3 MPa to 30 MPa, and in some embodiments in the range of 2 MPa and 20 MPa. Adjusting, for example, the concentration and activity of the initiator, the concentration of each of the reactive monomers, the temperature, the concentration of the chain transfer agent, and the solvent using techniques known in the art can control the molecular weight of the fluoropolymer.

When carrying out polymerization, the chain transfer agents having the cure site and/or the cure site monomers can be fed into the reactor by batch charge or continuously feeding. Because feed amount of chain transfer agent and/or cure site monomer is relatively small compared to the monomer feeds, continuous feeding of small amounts of chain transfer agent and/or cure site monomer into the reactor can be achieved by blending the nitrogen-containing monomer or chain transfer agent in one or more monomers. Examples of monomers useful for such a blend include HFP and PMVE. Perfluorinated ethers are typically liquids and may be pre-emulsified with an emulsifier before its copolymerization with the other comonomers, for example, addition of a gaseous fluoroolefin.

While Int. Appl. Pub. No. W02019/215636 (Hintzer et al.) reports that fluoropolymers with very low amounts of fluorinated alkanoic acid or its salts can be made from a method that includes treating fluoropolymer particles with an organic liquid, the process of the present disclosure provides an aqueous dispersion of fluoropolymer that as polymerized has not more than 25 nanograms per gram of the perfluorooctanoic acid or salt thereof “As polymerized” refers to the fluoropolymer in the aqueous dispersion before any work-up or post-processing steps. Thus, “as polymerized” refers to the fluoropolymer in the aqueous dispersion before any treatment with an organic liquid. In some embodiments, the process of the present disclosure does not include contacting the aqueous dispersion with a treatment composition comprising an organic liquid (e.g., one that is not miscible with water at ambient conditions such as a linear, branched, or cyclic hydrocarbon or a mixture thereof, including gasoline and kerosene and any of those disclosed in Int. Appl. Pub. No. W02019/215636 (Hintzer et al.)). However, in some embodiments, it may be useful to treat the aqueous dispersion with an organic liquid (e.g., one that is not miscible with water at ambient conditions such as a linear, branched, or cyclic hydrocarbon or a mixture thereof, including gasoline and kerosene and any of those disclosed in Int.

Appl. Pub. No. W02019/215636 (Hintzer et al.)), at least one of simultaneously with or subsequent to contacting the aqueous dispersion with a mineral acid, to further reduce the amount of perfluorinated perfluoroalkanoic acid or salt thereof or perfluoroalkane sulfonic acid or salt thereof or to remove the fluorinated emulsifier described above or a non-fluorinated emulsifier. For example, the amount of fluorinated emulsifier acid or its salt may be reduced to less than 5000 ppb, less than 2000 ppb, less than 1000 ppb, or less than 500 ppb (based on the weight of the fluoropolymer).

While U.S. Pat. No. 7,358,296 (Bläde et al.) reports that fluoropolymers with very low amounts of fluorinated alkanoic acid or its salts or other fluorinated emulsifiers can be made from a method that includes contacting an aqueous fluoropolymer dispersion with an anion exchange resins, the process of the present disclosure provides an aqueous dispersion of fluoropolymer that as polymerized has not more than 25 nanograms per gram of the perfluorooctanoic acid or salt thereof. As described above, “as polymerized” would refer to the fluoropolymer in the aqueous dispersion before contact with any anion exchange resin. In some embodiments, the process of the present disclosure does not include contacting the aqueous dispersion with an anion exchange resin. However, in some embodiments, it may be useful to treat the aqueous dispersion with an anion exchange resin (e.g., using an anion exchange resin as described in U.S. Pat. No. 7,358,296 (Bläde et al.)) to further reduce the amount of perfluorinated perfluoroalkanoic acid or salt thereof or perfluoroalkane sulfonic acid or salt thereof or to remove the fluorinated emulsifier described above. The concentration of the aqueous dispersion of the fluoropolymer subjected to the anion exchange may typically be from 5 to 40 wt.% or 15 to 30 wt.%. The anion exchange process can typically be run at operation temperatures from about 10° C. to about 50° C. or from 15° C. to 35° C. The level of sulfonic acids and their salts can be reduced to below 15 ppb, below 10 ppb, or below 5 ppb (based on the content of fluoropolymer).

The process of the present disclosure can include, in some embodiments, coagulating, washing, and drying the fluoropolymer. Any coagulant which is commonly used for coagulation of a fluoropolymer latex may be used, and it may, for example, be an acid (e.g., nitric acid, hydrochloric acid, or sulfuric acid), which would typically lower the pH of the aqueous dispersion to 4 or below, a water-soluble organic liquid (e.g., alcohol or acetone), or a water soluble salts (e.g., calcium chloride, magnesium chloride, aluminum chloride or aluminum nitrate). In some embodiments, it may be useful to select a coagulant that does not include metal cations to provide a low level (e.g., not more than 20 ppm metal cations) in the fluoropolymer. The amount of the coagulant to be added may be in range of 0.001 to 20 parts by mass, for example, in a range of 0.01 to 10 parts by mass per 100 parts by mass of the aqueous dispersion of the fluoropolymer. Alternatively, or additionally, aqueous dispersion may be frozen for coagulation. The coagulated fluoropolymer can be collected by filtration and washed with water. The washing water may, for example, be ion exchanged water, pure water or ultrapure water. The amount of the washing water may be from 1 to 5 times by mass to the fluoropolymer, whereby the amount of the emulsifier attached to the fluoropolymer can be reduced. Drying the fluoropolymer can then be carried out at ambient temperature or at an elevated temperature, for example, in a range from 50° C. to 150° C. or 75° C. to 125° C. Drying can be carried out at ambient pressure or reduced pressure. The process of the present disclosure may be useful for making fluoropolymers that are also free of metal cations or comprises not more than 20 parts per million metal cations (e.g., alkaline earth metal ions, alkali metal ions, and aluminum ions). It is desirable to avoid metal cations since metal cations may be undesired impurities in many end-use applications, for example, in the electronic, semiconductor, optical, medical and pharmaceutical industries. A low content of metal cations in the composition of the present disclosure can be achieved by carrying out the polymerization in the absence of metal salt-containing initiators, emulsifiers, buffers, and coagulants.

The process of the present disclosure is useful for making amorphous fluoropolymers, in some embodiments, amophous, curable fluoropolymers. Amorphous fluoropolymers may have a glass- transition temperature (T_{g}) of less than 26° C., or less than 20° C., or less than 0° C., for example, in a range of from about −160° C. to about +19° C., from about −40° C. up to 12° C., from about −50° C. up to +15° C., or from about −55° C. up to +19° C. In some embodiments, amorphous fluoropolymers have a glass-transition temperature between −160° C. and −40° C. Amorphous fluoropolymers may have a Mooney viscosity (ML 1+10 at 121° C.) of from about 2 to about 250, 2 to about 200, from 10 to 100, or from 20 to 70.

If the amorphous fluoropolymer is perfluorinated, typically at least 50 mole percent (mol %) of its interpolymerized units are derived from TFE, optionally including HFP. The balance of the interpolymerized units of the amorphous fluoropolymer (e.g., 10 to 50 mol %) is made up of one or more perfluorinated vinyl ethers or perfluorinated allyl ethers as described above in any of their embodiments and a cure site monomer as described above in any of its embodiments. In some embodiments, the molar ratio of units derived from TFE comonomer units to comonomer units derived from the perfluorinated vinyl ethers or perfluorinated allyl ethers described above may be, for example, from 1:1 to 4:1, wherein the unsaturated ethers may be used as single compounds or as combinations of two or more of the unsaturated ethers. Typical compositions comprise from 44-62 wt. % TFE and 38-56 wt. % PMVE and from 0.1-10 wt. % cure site monomer and from 0-10 wt. % of other comonomers or modifiers with the amount of ingredients being selected such that the total amount is 100 wt. %.

If the amorphous fluoropolymer is not perfluorinated, it typically contains from about 5 mol % to about 90 mol % of its interpolymerized units derived from TFE, CTFE, and/or HFP; from about 5 mol % to about 90 mol % of its interpolymerized units derived from VDF, ethylene, and/or propylene; up to about 40 mol % of its interpolymerized units derived from a perfluorinated vinyl ether or perfluorinated allyl ether as described above in any their embodiments; and from about 0.1 mol % to about 5 mol %, in some embodiments from about 0.3 mol % to about 2 mol %, of a cure site monomer. Some typical compositions comprise from about 22-30 wt. % TFE, 30-38 wt. % VDF, 34-42 wt. % HFP and from 0.1-10 wt. % cure site monomer and from 0-10 wt. % of other comonomers or modifiers with the amount of ingredients being selected such that the total amount is 100 wt. %.

Examples of amorphous fluoropolymers that can be prepared by the process of the present disclosure include a TFE/perfluoromethyl vinyl ether (PMVE) copolymer, TFE/perfluoromethyl allyl ether (PMVE) copolymer, a TFE/CF₂═CFOC₃F₇ copolymer, a TFE/CF₂═CFCF₂OC₃F₇ copolymer, a TFE/CF₂═CFOCF₃/CF₂═CFOC₃F₇ copolymer, TFE/CF₂═CFCF₂OCF₃/CF₂═CFCF₂OC₃F₇ copolymer, and a TFE/ HFP copolymer. In some embodiments, the process of the present disclosure is useful for making a TFE/propylene copolymer, a TFE/propylene/VDF copolymer, a VDF/HFP copolymer, a TFE/VDF/HFP copolymer, a TFE/ethyl vinyl ether (EVE) copolymer, a TFE/butyl vinyl ether (BVE) copolymer, a TFE/EVE/BVE copolymer, a VDF/CF₂═CFOC₃F₇ copolymer, an ethylene/HFP copolymer, a CTFE/VDF copolymer, a TFE/VDF copolymer, a TFE/VDF/PMVE/ethylene copolymer, and a TFENDF/CF₂═CFO(CF₂)₃₀CF₃ copolymer. Each of the aforementioned copolymers may also contain a monomeric unit having a cure site.

In some embodiments, fluoropolymer made by the process of the present disclosure further comprises —SO₂X groups, wherein X is independently F, —NZH, —NZSO₂(CF₂)₁₋₆SO₂X′, —NZ[SO₂(CF₂)ₐSO₂NZ]₁₋₁₀SO₂(CF₂)ₐSO₂X′ (in which each a is independently 1 to 6, 1 to 4, or 2 to 4), or —OZ. In some embodiments, X is independently —F, —NZH, or —OZ. X′ is independently —NZH or —OZ (in some embodiments, —OZ). In any of these embodiments, each Z is independently a hydrogen, an alkali metal cation (e.g., sodium or lithium) or a quaternary ammonium cation. Fluoropolymers comprising —SO₂X groups can be prepared by including perfluorinated monomers such as those represented by formula CF₂═CF(CF₂)₀₋₁—(OC_{b}F_{2b})_{c}—O—(CₑF₂ₑ)—SO₂X in the aqueous dispersion. In this formula, b is a number from 2 to 8, c is a number from 0 to 2, and e is a number from 1 to 8. In some embodiments, b is a number from 2 to 6 or 2 to 4. In some embodiments, e is a number from 1 to 6 or 2 to 4. In some embodiments, c is 0 or 1. In some embodiments, c is 0, and e is 2 or 4. In some embodiments, b is 3, c is 1, and e is 2. CₑF₂ₑ may be linear or branched. When c is 2, the b in the two C_{b}F_{2b} groups may be independently selected. In some embodiments, X is —F. Examples of useful vinyl or allyl ethers represented by formula CF₂═CF(CF₂)₀₋₁—(OC_{b}F_{2b})_{c}—O—(CₑF₂ₑ)—SO₂X include CF₂═CF—O—CF₂CF₂-SO₂F, CF₂═CFCF₂—O—CF₂CF₂—SO₂F, CF₂═CF—O—CF₂CF₂CF₂CF₂-SO₂F, CF₂═CFCF₂—O—CF₂CF₂CF₂CF₂—SO₂F, and CF₂═CFCF₂—O—CF(CF₃)—CF₂—O—(CF₂)ₑ—SO₂F. Fluoropolymers comprising —SO₂X groups can be prepared by copolymerizing the compound represented by formula CF₂═CF(CF₂)₀₋ₗ—(OC_{b}F_{2b})_{c}—O—(CₑF₂ₑ)—SO₂F with other perfluorinated monomomers, such as TFE and HFP, typically predominantly TFE. Perfluorinated allyl ethers and perfluorinated vinyl ethers as described above in any of their embodiments may also be included in the aqueous dispersion. The perfluorinated allyl ethers and perfluorinated vinyl ethers may be present in the aqueous dispersion in any useful amount, in some embodiments, in an amount of up to 10, 7.5, or 5 mole percent, based on the total amount of fluorinated monomers. In some embodiments, the aqueous dispersion includes up to 40, 35, 30, 25, or 20 mole percent of at least one compound represented by formula CF₂═CF(CF₂)₀₋ₗ—(OC_{b}F_{2b})_{c}—O—(CₑF₂ₑ)—SO₂F, in any of its embodiments described above, based on the total amount of fluorinated monomers. Hydrolysis and reactions to make sulfonimides and polysulfonimides can then be carried out on the polymeric sulfonyl fluorides using methods known in the art. Fluoropolymers comprising —SO₂X groups are often referred to as ionomers and may be useful, for example, in the manufacture of polymer electrolyte membranes for use in fuel cells or other electrolytic cells. lonomers having a wide range of —SO2X equivalent weight can be prepared, for example, in a range from 300 to 2000, 800 to 2000, 950 to 2000, 1000 to 2000, 300 to 1400, 300 to 1300, 300 to 1200, 400 to 1200, or 400 to 1000. In general, the —SO₂X equivalent weight of the copolymer refers to the weight of the copolymer containing one mole of —SO₂X groups, wherein X is as defined above in any of its embodiments. The process of the present disclosure can be useful for making ionomers with a low amount of ionic end groups without the need for the extra process step of post-fluorination.

The process of the present disclosure is also useful for preparing thermoplastic fluoropolymers. The thermoplastic fluoropolymer is semi-crystalline and may have a melting point in a range from 100° C. to 340° C. In some embodiments, the semi-crystalline fluoropolymer prepared by the process of the present disclosure has a melting point of from about 250° C. to about 326° C., 286° C. to 326° C., or from 220° C. to 285° C. The semi-crystalline fluoropolymer made by the process of the present disclosure can have a melt flow index (MFI at 372° C. and 5 kg load) of 0.1-100 grams/10 minutes, in some embodiments, 0.1-60 grams/10 minutes, 0.1-50 grams/10 minutes, or 30±10 grams/10 minutes.

Suitable semi-crystalline fluorinated thermoplastic polymers made by the process of the present disclosure include those having interpolymerized units derived solely from (i) TFE, (ii) more than 5 weight percent of one or more ethylenically unsaturated copolymerizable fluorinated monomers other than TFE. Copolymers of TFE and HFP with or without other perfluorinated comonomers are known in the art as FEP's (fluorinated ethylene propylene). In some embodiments, the semi-crystalline fluorinated thermoplastic prepared by the process of the present disclosure is a copolymer of a fluorinated olefin and at least one of a fluorinated vinyl ether or fluorinated allyl ether. In some of these embodiments, the fluorinated olefin is TFE. Copolymers of TFE and perfluorinated alkyl or allyl ethers are known in the art as PFA's (perfluorinated alkoxy polymers). In these embodiments, the perfluorinated vinyl ether or perfluorinated allyl ether units are present in the copolymer in an amount in a range from 0.01 mol % to 15 mol %, in some embodiments, 0.01 mol % to 10 mol %, and in some embodiments, 0.05 mol % to 5 mol %.

The perfluorinated vinyl ether or perfluorinated allyl ether may be any of those described above. In some embodiments, the semi-crystalline fluoropolymer is made by copolymerizing 30 to 70 wt. % TFE, 10 to 30 wt. %, HFP, and 0.2 to 50 wt. % of one or more perfluorinated vinyl ethers or perfluorinated allyl ethers, including any of those described above.

In some embodiments of the process of the present disclosure the fluoropolymer is a semi-crystalline thermoplastic derived from copolymerizing 30 to 70 wt. % TFE, 10 to 30 wt. %, HFP, and 5 to 50 wt. % of a third ethylenically unsaturated fluorinated comonomer other than TFE and HFP. For example, such a fluoropolymer may be derived from copolymerization of a monomer charge of TFE (e.g., in an amount of 45 to 65 wt. %), HFP (e.g., in an amount of 10 to 30 wt. %), and VDF (e.g., in an amount of 15 to 35 wt. %). Copolymers of TFE, HFP and vinylidenefluoride (VDF) are known in the art as THV.

Another example of a useful semi-crystalline thermoplastic is one derived from copolymerization of a monomer charge of TFE (e.g., from 45 to 70 wt %), HFP (e.g., from 10 to 20 wt %), and an alpha olefin hydrocarbon ethylenically unsaturated comonomer having from 1 to 3 carbon atoms, such as ethylene or propylene (e.g., from 10 to 20 wt. %). Another example of a useful semi-crystalline thermoplastic is one derived from TFE and an alpha olefin hydrocarbon ethylenically unsaturated comonomer. Examples of polymers of this subclass include a copolymer of TFE and propylene and a copolymer of TFE and ethylene (known as ETFE). Such copolymers are typically derived by copolymerizing from 50 to 95 wt. %, in some embodiments, from 85 to 90 wt. %, of TFE with from 50 to 15 wt. %, in some embodiments, from 15 to 10 wt. %, of the comonomer. Still other examples of useful semi-crystalline thermoplastics include polyvinylidene fluoride (PVDF) and a VdF/TFE/CTFE including 50 to 99 mol % VdF units, 30 to 0 mol % TFE units, and 20 to 1 mol % CTFE units. Other fluoropolymers that may be prepared by the process of the present disclosure include fluoroplastics derived solely from VDF and HFP. These semi-crystalline thermoplastics typically have interpolymerized units derived from 99 to 67 weight percent of VDF and from 1 to 33 weight percent HFP, more in some embodiments, from 90 to 67 weight percent VDF and from 10 to 33 weight percent HFP.

The aqueous dispersion of a semi-crystalline fluoropolymer in the process of the present disclosure can also contain low molecular weight PTFE, the so-called micropowders or waxes optionally modified with HFP, and/or perfluorinated vinyl or allyl ethers, including any of those described above.

In some embodiments, the semi-crystalline fluoropolymer has at least 89% by weight of units derived from TFE and from about 0.5% to about 6%, in some embodiments, from about 0.5% to about 4% by weight of units derived from at least one perfluorinated vinyl or allyl ether comonomer such as any of those described above in any of their embodiments. In some embodiments, the semi-crystalline fluoropolymer has from 94 to 99% by weight units derived from TFE and from 1 to 5% by weight of units derived from the at least one perfluorinated vinyl or allyl ether and up to 6% by weight, or up to 4.4% by weight of units derived from HFP.

In some embodiments, the semi-crystalline fluoropolymer can have from 0.5 to 4.0% by weight of units derived from the at least one perfluorinated alkyl allyl ether represented by formula CF₂═CF—CF₂—O—Rf, wherein Rf is perfluoromethyl. In some embodiments, the semi-crystalline fluoropolymer can have from 0.5 to 5.0% by weight of units derived from the at least one perfluorinated alkyl allyl ether represented by formula CF₂═CF—CF₂—O—Rf, wherein Rf is perfluoroethyl. In some embodiments, the semi-crystalline fluoropolymer can have from 0.5 to 6.0% by weight of units derived from the at least one perfluorinated alkyl allyl ether represented by formula CF₂═CF—CF₂—O—Rf, wherein Rf is perfluoropropyl or perfluorobutyl. In some embodiments, the semi-crystalline fluoropolymer can have from 1.0 to 6.0% by weight of units derived from the at least one perfluorinated alkyl allyl ether represented by formula CF₂═CF—CF₂—O—Rf, wherein Rf has from 5 to 10 carbon atoms.

Any of the semi-crystalline fluoropolymers described above can be modified with Br-, I- and/or CN-containing comonomers. The cure site monomers described above can be used for this purpose. These modifiers are typically added near the end of the polymerization reaction, for example during the last 5% to 10% of the polymerization process; the overall modifier content is typically less than 1% by weight based on the weight the semi-crystalline fluoropolymer.

The process of the present disclosure can include blending two or more fluoropolymers made by the process. Also, a fluoropolymer made by the process of the present disclosure can be combined with a fluoropolymer made by another process. In some embodiments, two or more different amorphous fluoropolymers having different reactive cure sites can be combined to provide a dual-cure system. In some embodiments, an amorphous fluoropolymer is combined with a semi-crystalline fluoropolymer. Such blends may contain the amorphous fluoropolymer in an amount of from about 10% up to about 90% by weight based on the total weight of the blend which is 100% by weight. The blend may contain the semi-crystalline fluoropolymer in an amount from about 10% by weight up to 90% by weight based on the total weight of the blend which 100% by weight. The blends may be prepared in various ways. In some embodiments, an aqueous dispersion of amorphous fluoropolymer particles is blended with an aqueous dispersion of semi-crystalline fluoropolymer. The resulting dispersion may be coagulated, for example, by one or more methods described herein. A procedure for blending latexes, is described in U.S. Pat. No. 6,720,360 (Grootaert et al.). A further example includes dry blending coagulated amorphous fluoropolymer particles with particles of semi-crystalline fluoropolymer.

In some embodiments, the blend of the amorphous fluoropolymer and the semi-crystalline fluoropolymer has a total extractable amount of perfluorinated C₈—C₁₄ alkanoic acids or its salts of less than 300 ppb, 250 ppb, 200 ppb, 150 ppb or 100 ppb, based on the weight of the fluoropolymer. In some embodiments, the blends have a total amount of perfluorooctanoic acid or its salts of less than 50 ppb or less than 25 ppb, 20 ppb, 15 ppb, or 10 ppb.

A fluoropolymer made by the process of the present disclosure including at least one cure site monomer is crosslinkable and can be blended with a cure system. A commonly used cure system is based on a peroxide cure reaction using appropriate curing compounds having or creating peroxides. It is generally believed that the bromine or iodine atoms are abstracted in the free radical peroxide cure reaction, thereby causing the fluoropolymer molecules to cross-link and to form a network. Suitable organic peroxides are those which generate free radicals at curing temperatures. A dialkyl peroxide or a bis(dialkyl peroxide) which decomposes at a temperature above the extrusion temperature may be useful. A di-tertiarybutyl peroxide having a tertiary carbon atom attached to the peroxy oxygen, for example, may be useful. Among the peroxides of this type are 2,5-dimethyl-2,5-di(tertiarybutylperoxy)hexyne-3 and 2,5-dimethyl-2,5-di(tertiarybutylperoxy)hexane. Other useful peroxides include dicumyl peroxide, dibenzoyl peroxide, tertiarybutyl perbenzoate, alpha,alpha'-bis(t-butylperoxy-diisopropylbenzene), and di[1,3-dimethyl-3-(t-butylperoxy)-butyl]carbonate. A tertiary butyl peroxide having a tertiary carbon atom attached to a peroxy oxygen may be a useful class of peroxides. Further examples of peroxides include 2,5-dimethyl-2,5-di(t-butylperoxy)hexane; dicumyl peroxide; di(2-t-butylperoxyisopropyl)benzene; dialkyl peroxide; bis (dialkyl peroxide); 2,5-dimethyl-2,5-di(tertiarybutylperoxy)3-hexyne; dibenzoyl peroxide; 2,4-dichlorobenzoyl peroxide; tertiarybutyl perbenzoate; di(t-butylperoxy-isopropyl)benzene; t-butyl peroxy isopropylcarbonate, t-butyl peroxy 2-ethylhexyl carbonate, t-amyl peroxy 2-ethylhexyl carbonate, t-hexylperoxy isopropyl carbonate, di[1,3-dimethyl-3-(t-butylperoxy)butyl] carbonate, carbonoperoxoic acid, O,O′-1,3-propanediyl OO,OO′-bis(1,1-dimethylethyl) ester, and combinations thereof The amount of peroxide curing agent used generally will be at least 0.1, 0.2, 0.4, 0.6, 0.8, 1, 1.2, or even 1.5; at most 2, 2.25, 2.5, 2.75, 3, 3.5, 4, 4.5, 5, or even 5.5 parts by weight per 100 parts of the fluoropolymer may be used.

A peroxide cure system may also include one or more coagent. Typically, the coagent includes a polyunsaturated compound which is capable of cooperating with the peroxide to provide a useful cure. These coagents can be added in an amount between 0.1 and 10 parts per hundred parts fluoropolymer, in some embodiments between 2 and 5 parts per hundred parts fluoropolymer. Examples of useful coagents include tri(methyl)allyl isocyanurate (TMAIC), triallyl isocyanurate (TAIC), tri(methyl)allyl cyanurate, poly-triallyl isocyanurate (poly-TAIC), triallyl cyanurate (TAC), xylylene-bis(diallyl isocyanurate) (XBD), N,N′-m-phenylene bismaleimide, diallyl phthalate, tris(diallylamine)-s-triazine, triallyl phosphite, 1,2-polybutadiene, ethyleneglycol diacrylate, diethyleneglycol diacrylate, and combinations thereof. Another useful coagent may be represented by the formula CH2═CH—Rfl—CH═CH2 wherein Rfl may be a perfluoroalkylene having from 1 to 8 carbon atoms. Such coagents can provide enhanced mechanical strength to the final cured elastomer.

Examples of curatives for fluoropolymers with nitrile cure sites include fluoroalkoxy organophosphohium, organoammonium, or organosulfonium compounds (e.g., Int. Pat. Appl. Pub. No. WO 2010/151610 (Grootaert et al.), bis-aminophenols (e.g., U.S. Pat. Nos. 5,767,204 (Iwa et al.) and 5,700,879 (Yamamoto et al.)), bis-amidooximes (e.g., U.S. Pat . No. 5,621,145 (Saito et al.)), and ammonium salts (e.g., U.S. Pat . No. 5,565,512 (Saito et al.)). In addition, organometallic compounds of arsenic, antimony, and tin (e.g., allyl-, propargyl-, triphenyl- allenyl-, and tetraphenyltin and triphenyltin hydroxide) as described in U.S. Pat. Nos. 4,281,092 (Breazeale) and 5,554,680 (Ojakaar) and ammonia-generating compounds may be useful. “Ammonia-generating compounds” include compounds that are solid or liquid at ambient conditions but that generate ammonia under conditions of cure. Examples of such compounds include hexamethylenetetramine (urotropin), dicyandiamide, and metal-containing compounds of the formula A^{w+}(NH₃)ₓY^{w-}, wherein A^{w+} is a metal cation such as Cu²⁺, Co²⁺, Co³⁺, Cu⁺, and Ni^{2 +}; w is equal to the valance of the metal cation; Y^{w-} is a counterion (e.g., a halide, sulfate, nitrate, acetate); and x is an integer from 1 to about 7. Further examples include substituted and unsubstituted triazine derivatives such as those of the formula:

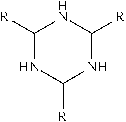

wherein R is a hydrogen atom or a substituted or unsubstituted alkyl, aryl, or arylalkylene group having from 1 to about 20 carbon atoms. Specific useful triazine derivatives include hexahydro-1,3,5-s-triazine and acetaldehyde ammonia trimer.

Additives such as carbon black, stabilizers, acid acceptors, plasticizers, lubricants, fillers, and processing aids typically utilized in fluoropolymer compounding can be used with fluoropolymers made by the process of the present disclosure, provided they have adequate stability for the intended service conditions. In particular, low temperature performance can be enhanced by incorporation of perfluoropolyethers as described for example, U.S. Pat. No. 5,268,405 (Ojakaar et al.) Carbon black fillers can be employed in fluoropolymers as a means to balance modulus, tensile strength, elongation, hardness, compression set, abrasion resistance, conductivity, and processability of the compositions.

### Some Embodiments of the Disclosure

In a first embodiment, the present disclosure provides a process for making a fluoropolymer, the process comprising:
providing an aqueous mixture comprising a fluorinated monomer, a fluoroalkyl sulfinic acid or salt thereof having from one to three carbon atoms in the fluoroalkyl group, and an oxidizing agent capable of oxidizing the fluoroalkyl sulfinic acid or salt thereof; and
polymerizing the fluorinate monomer under free radical conditions to provide an aqueous dispersion of the fluoropolymer, wherein the amount of perfluorooctanoic acid or salt thereof in the aqueous dispersion of the fluoropolymer as polymerized is not more than 25 nanograms per gram of the fluoropolymer.

In a second embodiment, the present disclosure provides the process of the first embodiment, wherein the fluoroalkyl sulfinic acid or salt thereof has three carbon atoms in the fluoroalkyl group.

In a third embodiment, the present disclosure provides the process of the first or second embodiment, wherein the fluorinated monomer is a perfluorinated monomer.

In a fourth embodiment, the present disclosure provides a process for making a fluoropolymer, the process comprising:
providing an aqueous mixture comprising perfluorinated monomers, a fluoroalkyl sulfinic acid or salt thereof having from one to three carbon atoms in the fluoroalkyl group, and an oxidizing agent capable of oxidizing the fluoroalkyl sulfinic acid or salt thereof; and
polymerizing the perfluorinated monomers under free radical conditions to provide an aqueous dispersion of the fluoropolymer, wherein the amount of perfluorooctanoic acid or salt thereof in the aqueous dispersion of the fluoropolymer as polymerized is not more than 25 nanograms per gram of the fluoropolymer.

In a fifth embodiment, the present disclosure provides the process of the fourth embodiment, wherein the fluoroalkyl sulfinic acid or salt thereof is represented by formula:

R_{f}SO₂M

wherein R_{f} is perfluoromethyl, perfluoroethyl, or perfluoropropyl, M is a hydrogen atom or an ammonium, sodium, or potassium cation.

In a sixth embodiment, the present disclosure provides the process of the fourth or fifth embodiment, wherein the fluoroalkyl sulfinic acid or salt thereof is perfluoromethanesulfinic acid.

In a seventh embodiment, the present disclosure provides the process of any one of the first to sixth embodiments, wherein the fluoropolymer has an end group comprising at least one of —CF₃,—CF₂H, —CFH₂, or —CH₃, and wherein an absorbance ratio determined by calculating the integrated peak intensity within the range of 1840 cm⁻¹-1620 cm⁻¹ to the integrated peak intensity in the range 2740 cm⁻¹-2220⁻¹ in a Fourier-transform infrared spectrum of the fluoropolymer is less than 0.08.

In an eighth embodiment, the present disclosure provides the process of any one of the first to seventh embodiments, wherein the fluorinated monomer comprises at least one of tetrafluoroethylene, hexafluoropropylene, a perfluorinated vinyl ether, or a perfluorinated allyl ether.

In a ninth embodiment, the present disclosure provides the process of the eighth embodiment, wherein the perfluorinated vinyl ether is represented by formula CF₂═CF(OCₙF₂ₙ)_{z}ORf, and wherein the perfluorinated allyl ether is represented by formula CF₂═CFCF₂(OCₙF₂ₙ)_{z}ORf, wherein n is independently from 1 to 6, z is independently 0, 1, or 2, and Rf is independently a linear or branched perfluoroalkyl group having from 1 to 8 carbon atoms and optionally interrupted by one or more —O-groups.

In a tenth embodiment, the present disclosure provides the process of any one of the first to ninth embodiments, wherein the fluorinated monomer comprises tetrafluoroethylene and at least one of a perfluorinated vinyl ether or a perfluorinated allyl ether, wherein the perfluorinated vinyl ether or the perfluorinated allyl ether is perfluoromethyl vinyl ether, perfluoropropyl vinyl ether, perfluoro-3-methoxy-n-propyl vinyl ether, perfluoro-3-methoxy-n-propyl allyl ether, perfluoromethyl allyl ether, perfluoropropyl allyl ether, or a combination thereof.

In an eleventh embodiment, the present disclosure provides the process of any one of the first to tenth embodiments, wherein the aqueous mixture further comprises a cure site monomer having at least one of a bromo-, iodo-, or cyano- cure site.

In a twelfth embodiment, the present disclosure provides the process of the eleventh embodiment, wherein the cure site monomer comprises at least one of perfluoro(8-cyano-5-methyl-3,6-dioxa-l-octene), CF₂═CFO(CF₂)LCN, CF₂═CFO(CF₂)ᵤOCF(CF₃)CN, CF₂═CFO[CF₂CF(CF₃)O]_{q}(CF₂O)_{y}CF(CF₃)CN, or CF₂═CF[OCF₂CF(CF₃)]ᵣO(CF₂)ₜCN, wherein L is in a range from 2 to 12; u is in a range from 2 to 6; q is in a range from 0 to 4; y is in a range from 0 to 6; r is in a range from 1 to 2; and t is in a range from 1 to 4.

In a thirteenth embodiment, the present disclosure provides the process of any one of the first to twelfth embodiments, wherein the aqueous mixture further comprises a fluorinated emulsifier other than a perfluorinated alkanoic acid.

In a fourteenth embodiment, the present disclosure provides the process of the thirteenth embodiment, wherein the fluorinated emulsifier is represented by formula

[R_{f}—O—L—COO^{-]}ᵢXᵢ⁺

wherein L represents a linear or branched or cyclic partially fluorinated alkylene (alkanediyl) group or an aliphatic hydrocarbon group, Rf represents a linear or branched, partially or fully fluorinated aliphatic group or a linear or branched partially or fully fluorinated group interrupted once or more than once by an ether oxygen atom, Xᵢ⁺ represents a cation having the valence i and i is 1, 2 and 3.

In a fifteenth embodiment, the present disclosure provides the process of any one of the first to fourteenth embodiments, wherein the oxidizing agent comprises a persulfate salt.

In a sixteenth embodiment, the present disclosure provides the process any one of the first to fifteenth embodiments, wherein the oxidizing agent comprises a bromate, chlorate, hypochlorite, or cerium salt.

In a seventeenth embodiment, the present disclosure provides the process of any one of the first to sixteenth embodiments, wherein the process does not include contacting the aqueous dispersion with a treatment composition comprising an organic liquid.

In an eighteenth embodiment, the present disclosure provides the process of any one of the first to seventeenth embodiments, wherein the process does not include contacting the aqueous dispersion with an anion exchange resin.

In a nineteenth embodiment, the present disclosure provides the process of any one of the first to eighteenth embodiments, further comprising coagulating the fluoropolymer.

In a twentieth embodiment, the present disclosure provides the process of any one of the first to nineteenth embodiments, further comprising drying the fluoropolymer.

In a twenty-first embodiment, the present disclosure provides process of any one of the first to twentieth embodiments, wherein the amount of perfluoroalkanoic acids having from 8 to 14 carbon atoms or salts thereof or perfluoroalkane sulfonic acids having from 8 to 14 carbon atoms or salts thereof in the aqueous dispersion of the fluoropolymer as polymerized is not more than 150 nanograms per gram of the fluoropolymer.

In a twenty-second embodiment, the present disclosure provides process of any one of the first to twenty-first embodiments, wherein the fluoropolymer is an amorphous fluoropolymer.

In a twenty-third embodiment, the present disclosure provides the process of the twenty-second embodiment, wherein the amorphous fluoropolymer has a Mooney viscosity (ML 1+10 at 121° C.) in a range from 2 to 250.

In a twenty-fourth embodiment, the present disclosure provides the process of the twenty-second or twenty-third embodiments, further comprising combining the amorphous fluoropolymer with a semi-crystalline fluoropolymer.

In a twenty-fifth embodiment, the present disclosure provides process of any one of the first to twenty-first embodiments, wherein the fluoropolymer is a semi-crystalline fluoropolymer.

In a twenty-sixth embodiment, the present disclosure provides process of any one of the first to twenty-fifth embodiments, wherein the fluoropolymer comprises —SO₂X groups, wherein X is independently —F or —OZ, wherein each Z is independently a hydrogen, an alkali metal cation, or a quaternary ammonium cation.

In a twenty-seventh embodiment, the present disclosure provides a fluoropolymer made by the process of any one of the first to twenty-sixth embodiments.

In order that this disclosure can be more fully understood, the following examples are set forth. It should be understood that these examples are for illustrative purposes only and are not to be construed as limiting this disclosure in any manner.

### EXAMPLES

All materials are commercially available, for example from Sigma-Aldrich Chemical Company, Milwaukee, WI, USA, or known to those skilled in the art, unless otherwise stated or apparent.

The following abbreviations are used in this section: g=grams, ng=nanograms, min=minutes, h=hours, ° C.=degrees Celsius, and wt %=weight percent, GC=gas chromatography, LC=liquid chromatography, MS=mass spectrometry, FTIR=Fourier transform infrared spectrophotometry, cm=centimeters, mL=milliliters, mmHg=millimeters mercury, DI=deionized, NMR=nuclear magnetic resonance, psi=pounds per square inch, Pa =Pascals, MPa=megaPascals, rpm=revolutions per minute, ppb=parts per billion.

### Characterization Methods

C₄-C₁₄ perfluoroalkyl monoacid analysis

The fluoropolymer dispersion samples were diluted ten times by weight with methanol prior to analysis by LC-MS/MS. Mixed standard solutions containing the C₄—C₁₄ acids were prepared in methanol at concentrations ranging from approximately 2000 ng/g to 0.1 ng/g. LC/MS (Agilent 6470

Triple Quad LCMS MAID 1665) is available from, Agilent Technologies, Santa Clara, CA, United States).

C₈-C₁₄ perfluoroalkyl monoacid analysis method

The isolated fluoropolymer was pulverized to a fine powder in a cryogrinder. The powder was extracted by mixing a sample of 1.0 g of the fine powder with 9 milliliters of methanol on a mechanical shaker. The samples were then spiked with a known amount of ¹³C₈-PFOA as an internal standard. The samples were analyzed using gas chromatography/mass spectrometry (GC/MS) using a model 6550 iFunnel Q-TOF LC/MS obtained from Agilent Technologies, Santa Clara, California. For the quantitation, standard solutions that included a known amount of PFOA and ¹³C₈-PFOA were prepared and measured as the same manner. The amounts of C₄ to C₁₀ perfluoroalkanoic acids were calculated with the calibration curve for PFOA (C₈). Two samples were run for each Example, and the results are shown in Table 2, below.

### Carbonyl End Groups Snalysis by FTIR

The total content of carboxyl, carboxylate, and carboxamide groups in the polymer is determined by measuring the integrated carbonyl absorbance (i.e., the total area of all peaks in the region 1,840-1,620 cm⁻¹) of thin polymer films using an FTIR spectrometer based on the method described in U.S. Pat. No. 8,604,137 (Grootaert et al.). The ionic end groups ratio was calculated from the formula below. Analysis was performed using a Perkin Elmer Frontier 100 FTIR (Perkin Elmer, Waltham, Mass.).

$$Ionic end groups ratio = \frac{Carbonyl group area [ 1 , 840 - 1 , 620 {cm}^{- 1} ]}{C - F over tone area [ 2 , 740 - 2 , 220 {cm}^{- 1} ]}$$

### Mooney Viscosity

Mooney viscosities can be determined in accordance with ASTM D1646 - 07(2012), 1 minute pre-heat and a 10 minute test at 121° C. (ML 1+10 @ 121° C.).

### Preparation of Perfluoromethanesulfinic Acid (CF₃SO₂H)

A 3-neck, 3,000-mL round bottom flask equipped with a mechanical stirrer, condenser, and a thermocouple was charged with 1,000 g tetrahydrofuran (THF) and NaBH₄ (56 g, 1.5 mol), and CF₃SO₂F (200 g, 1.3 mol) made by electrochemical fluorination of methane sulfonyl fluoride as described in U.S. Pat. No. 2,732,398 (Brice et al.)was added over one hour at 10° C. The mixture was warmed to 25° C. and stirred for 30 min. A 33% solution of H₂SO₄ (445 g) was added at 15° C. for over one hour. A solution of 120 g NaCl in 800 g DI water was added to get a phase split with the product in the top phase. The THF was removed from the product solution at 30° C. and 18 mmHg (2400 Pa) vacuum. The crude product was extracted with 150 g methyl tert-butyl ether (MTBE) and washed with 50 g NaCl in 150 g DI water. The MTBE was removed by distillation at 30 ° C. and 16 mmHg (2100 Pa) vacuum to obtain CF₃SO₂H (110 g, 0.8 mol) for a 62% yield confirmed by NMR.

### Preparation of Pentafluoroethylsulfinic Acid (C₂F₅SO₂H)

A 3-neck, 2000-mL round bottom flask equipped with a mechanical stirrer, condenser, and a thermocouple was charged with 500 g THF and NaBH4 (26 g, 0.7 mol), and C₂F₅SO₂F (125 g, 0.6 mol) made by electrochemical fluorination of ethane sulfonyl fluoride as described in U.S. Pat. No. 2,732,398 (Brice et al.) was added over one hour at 10° C. The mixture was warmed to 25° C. and stirred for 30 min. A 33% solution of H₂SO₄ (208 g) was added at 15° C. over one hour. A solution of 60 g NaCl in 400 g DI water was added to get a phase split with the product in the top phase. The THF was removed from the product solution at 30° C. and 18 mmHg (2400 Pa) vacuum. The crude product was extracted with 125 g MTBE and washed with 25 g NaCl in 75 g DI water. The MTBE was removed by distillation at 30° C. and 10 mmHg (1300 Pa) vacuum to obtain C₂F₅SO₂H (83.6 g, 0.5 mol) for a 74% yield confirmed by NMR.

### Example 1 (EX-1)

A 4-liter reactor was charged with 2,450 g of water, 5.2 g of ammonium persulfate ((NH₄)₂S₂O₈), 4.26 g of 28% aqueous solution of ammonium hydroxide (NH₄OH), 58 g of a 30% aqueous solution of CF₃—O—CF₂CF₂CF₂—O—CHFCF₂—COONH₄ with 1.5 wt % FC-70 added (based on the weight of the CF₃—O—CF₂CF₂CF₂—O—CHFCF₂—COONH₄), and 4 g of 38% CF₃SO₂H in water (0.011 mol). CF₃—O—CF₂CF₂CF₂—O—CHFCF₂—COONH₄ was prepared as described in U.S. Pat. No. 7,671,112 (Hintzer, et al.). FC-70 is a fluid commercially available from 3M Company, St Paul, Minn., under the trade designation “FLUORINERT FC-70.” The reactor was evacuated, the vacuum was broken, and it 5 was pressurized with nitrogen to 25 psi (0.17 MPa). This evacuation and pressurization were repeated three times. After removing oxygen, the reactor was heated to 72.2° C., and the vacuum was broken with perfluoromethyl vinyl ether (PMVE). The reactor was pressurized to 190 psi (1.3 MPa) with PMVE. The total precharge of PMVE and TFE was 455 g, and 142 g, respectively. The reactor was agitated at 650 rpm. As reactor pressure dropped due to monomer consumption in the polymerization reaction, PMVE and TFE were continuously fed to the reactor to maintain the pressure at 190 psi (1.3 MPa). A ratio of PMVE and TFE of 0.99 by weight was used for the polymerization. After 3.6 h, the monomers were discontinued, and the reactor was cooled.

The resulting dispersion had a solid content of 39.5 wt% and a pH of 2.4. The total amount of dispersion was 4,250 g. The dispersion was used for LC/MS analysis to determine PFOA level in the dispersion. The results are summarized in Table 1.

For the coagulation, the same amount of a MgCl₂/DI water solution was added to the latex. The solution contained 1.25 wt. % MgCl₂·6H₂O. The dispersion was coagulated and the solid was dried at 130° C. for 16 h. The resulting fluoroelastomer raw gum had a Mooney viscosity of 200at 121 ° C. The fluoroelastomer gum was used for LC/MS analysis to determine C₈-C₁₄ perfluoroalkyl monoacid levels in the fluoropolymer. The results are summarized in Table 2.

### Comparative Example 1 (CE-1)

A fluoropolymer was prepared and tested as in EX-1 except CF3SO2H was not used. The resulting fluoroelastomer raw gum had a Mooney viscosity of >200 at 121° C.

Comparative Example 2 (CE-2)

A fluoropolymer was prepared and tested as in EX-1 except the mole equivalent of 6.75 g of 48% perfluorobutane sulfinic acid (C₄F₉SO₂H) in water (0.011 mol) was used instead of CF₃SO₂H. C₄F₉SO₂H was prepared as described for CF₃SO₂H, with the exception that C₄F₉SO₂F was used in place of CF₃SO₂F.

### Example 2 (EX-2)

A fluoroelastomer was prepared and tested as in Example 1 except the mole equivalent of 5.1 g of 41% perfluoroethane sulfinic acid (C₂F₅SO₂H) in water (0.011 mol) was used instead of CF3SO2H.

The resulting dispersion had a solid content of 38.2 wt % and a pH of 2.8. The total amount of dispersion was 4,036 g. For the coagulation, the same amount of a MgCl₂/DI water solution was added to the latex. The solution contained 1.25 wt. % MgCl₂·6H₂O. The dispersion was coagulated and the solid was dried at 130° C. for 16 h. The dispersion was used for LC/MS analysis to determine PFOA level in the dispersion. The results are summarized in Table 1. The resulting fluoroelastomer raw gum had a Mooney viscosity of >200 at 121° C.

TABLE 1

| | Example or Comparative Example | | | |
|---|---|---|---|---|
| | EX-1 | CE-1 | CE-2 | EX-2 |
| Ionic end groups ratio | 0.05 | 0.09 | 0.05 | 0.06 |
| [Carbonyl/C-F over tone] | | | | |

C4-C14 perfluoroalkyl monoacid in dispersion (ppb)

| | | | | |
|---|---|---|---|---|
| C4 | 15.3 | 5.8 | >21,000 | 280 |
| C5 | 66.7 | 6.1 | 21.0 | 48.1 |
| C6 | 5.4 | <1.07 | 409 | 39.4 |
| C7 | 14.3 | 1.3 | 5.9 | 15.4 |
| C8 | 5.8 | <1.07 | 128 | 21.2 |
| C9 | 16.6 | 1.1 | 13.2 | 9.0 |
| C10 | 4.5 | <1.07 | 88.4 | 12.0 |
| C11 | 10.2 | <1.07 | 13.1 | 6.9 |
| C12 | 4.3 | <1.07 | 57.7 | 7.7 |
| C13 | 10.0 | 1.1 | 13 | 5.7 |
| C14 | 4.9 | <1.07 | 48.2 | 6.3 |
| (C₄-C₁₄) total | 158 | <21 | >21,798 | 452 |

TABLE 2
C₈-C₁₄ perfluoroalkyl monoacid polymer (ppb)

| Examples | EX-1 | CE-1 | CE-2 |
|---|---|---|---|
| PFOA (C₈) | 3.1 | 1.1 | 46.3 |
| C₉ | 12.6 | 1.4 | 34.2 |
| C₁₀ | 2.4 | 0.9 | 71.4 |
| C₁₁ | 6.9 | 1.3 | 30.4 |
| C₁₂ | 2.2 | 0.7 | 52.3 |
| C₁₃ | 5 | 1 | 26.2 |
| C₁₄ | 2 | 0.6 | 41.3 |

Various modifications and alterations of this disclosure may be made by those skilled the art without departing from the scope and spirit of the disclosure, and it should be understood that this disclosure is not to be unduly limited to the illustrative embodiments set forth herein.

1. A process for making a fluoropolymer, the process comprising:
providing an aqueous mixture comprising perfluorinated monomers, a fluoroalkyl sulfinic acid or salt thereof having from one to three carbon atoms in the fluoroalkyl group, and an oxidizing agent capable of oxidizing the fluoroalkyl sulfinic acid or salt thereof; and
polymerizing the perfluorinated monomers under free radical conditions to provide an aqueous dispersion of the fluoropolymer,
wherein the amount of perfluorooctanoic acid or salt thereof in the aqueous dispersion of the fluoropolymer as polymerized is not more than 25 nanograms per gram of the fluoropolymer.

2. The process of claim 1, wherein the fluoropolymer has an end group comprising at least one of —CF₃,—CF₂H, —CFH₂, or —CH₃, and wherein an absorbance ratio determined by calculating the integrated peak intensity within the range of 1840 cm⁻¹-1620 cm⁻¹ to the integrated peak intensity in the range 2740 cm⁻¹-2220 cm⁻¹ in a Fourier-transform infrared spectrum of the fluoropolymer is less than 0.08.

3. The process of claim 1, wherein the perfluorinated monomers comprise at least one of tetrafluoroethylene, hexafluoropropylene, a perfluorinated vinyl ether, or a perfluorinated allyl ether.

4. The process of claim 3, wherein the perfluorinated vinyl ether is represented by formula CF₂═CF(OCₙF₂ₙ)_{z}ORf and wherein the perfluorinated allyl ether is represented by formula CF₂═CFCF₂(OCₙF₂ₙ)_{z}ORf, wherein n is independently from 1 to 6, z is independently 0, 1, or 2, and Rf is independently a linear or branched perfluoroalkyl group having from 1 to 8 carbon atoms and optionally interrupted by one or more —O— groups.

5. The process of claim 1, wherein the perfluorinated monomers comprise tetrafluoroethylene and at least one of a perfluorinated vinyl ether or a perfluorinated allyl ether, wherein the perfluorinated vinyl ether or the perfluorinated allyl ether is perfluoromethyl vinyl ether, perfluoropropyl vinyl ether, perfluoro-3-methoxy-n-propyl vinyl ether, perfluoro-3-methoxy-n-propyl allyl ether, perfluoromethyl allyl ether, perfluoropropyl allyl ether, or a combination thereof

6. The process of claim 1, wherein the aqueous mixture further comprises a cure site monomer having at least one of a bromo-, iodo-, or cyano- cure site.

7. The process of claim 1, wherein the fluoroalkyl sulfinic acid or salt thereof is represented by formula:
R_{f}SO₂M
wherein R_{f} is perfluoromethyl, perfluoroethyl, or perfluoropropyl, M is a hydrogen atom or an ammonium, sodium, or potassium cation.

8. The process of claim 1, wherein the fluoroalkyl sulfinic acid or salt thereof is perfluoromethanesulfinic acid.

9. The process of claim 1, wherein the aqueous mixture further comprises a fluorinated emulsifier other than a perfluorinated alkanoic acid.

10. The process of claim 1, further comprising coagulating the fluoropolymer and optionally drying the fluoropolymer.

11. The process of claim 1, wherein the amount of perfluoroalkanoic acids having from 8 to 14 carbon atoms or salts thereof or perfluoroalkane sulfonic acids having from 8 to 14 carbon atoms or salts thereof in the aqueous dispersion of the fluoropolymer as polymerized is not more than 150 nanograms per gram of the fluoropolymer.

12. The process of claim 1, wherein the fluoropolymer is an amorphous fluoropolymer.

13. The process of claim 1, wherein the fluoropolymer is a semi-crystalline fluoropolymer.

14. The process of claim 1, further comprising combining the amorphous fluoropolymer with a semi-crystalline fluoropolymer.

15. (canceled)
